(19) United States
(12) Patent Application Publication
(10) Pub. No.: US 2024/0123840 A1
(43) Pub. Date: Apr. 18, 2024

(54) ELECTRIC POWER SUPPLY SYSTEM

(71) Applicant: ISUZU MOTORS LIMITED, Yokohama-shi (JP)

(72) Inventor: Makoto OGAWA, Fujisawa-shi (JP)

(21) Appl. No.: 18/375,535

(22) Filed: Oct. 1, 2023

(30) Foreign Application Priority Data
Oct. 13, 2022 (JP) 2022-164558

(51) Int. Cl. B60L 50/60; B60L 53/80

(52) U.S. Cl. CPC B60L 50/66; B60L 53/80; B60L 2210/10

(57) ABSTRACT

An electric power supply system mounted in a vehicle includes: a first battery that supplies electric power to a motor that drives the vehicle; a second battery that supplies electric power to the motor and is replaceable; and DC/DC converter that is connected between the second battery and the motor and converts an output voltage of the second battery to a predetermined voltage.

### CROSS REFERENCE TO RELATED APPLICATIONS

This application is entitled to the benefit of Japanese Patent Application No. 2022-164558, filed on Oct. 13, 2022, the disclosure of which including the specification, drawings and abstract is incorporated herein by reference in its entirety.

### Technical Field

The present disclosure relates to an electric power supply system mounted in a vehicle.

### BACKGROUND ART

Batteries for electric vehicles are required to satisfy the power performances and the necessary cruising distances of the vehicles, and specifications of the batteries are determined according to such requirements. The power performances of the vehicles are determined by the output electric powers of the batteries, and the cruising distances of the vehicles are determined by the capacities of the batteries. Accordingly, conventional electric vehicles are equipped with a battery having a large capacity and a high output electric power that satisfies both the cruising distance and the power performance.

However, mounting the battery having a large capacity and a high output electric power means to a user of a vehicle for traveling only a short distance that the vehicle is equipped with a battery having an unnecessarily large capacity (a large and heavy battery), which leads to an increase in weight and cost of the vehicle.

Patent Literature (hereinafter, referred to as “PTL”) 1 discloses a power source system that supplies electric power to a drive motor using two batteries of an output type and a capacitive type.

### CITATION LIST

### Patent Literature

PTL 1: Japanese Patent Application Laid-Open No. 2022-088964

### SUMMARY OF INVENTION

### Technical Problem

However, in PTL 1, for the user of a vehicle for traveling only a short distance, it is impossible to solve the problem of an increase in weight and cost of the vehicle for the capacity type battery.

An object of the present disclosure is to provide an electric power supply system capable of obtaining satisfactory power performance (desired power performance) and allowing a battery to be mounted according to a necessary cruising distance.

### Solution to Problem

An electric power supply system according to the present disclosure is an electric power supply system that is mounted in a vehicle and includes: a first battery that supplies electric power to a motor that drives the vehicle; a second battery that supplies electric power to the motor and is replaceable; and a DC/DC converter that is connected between the second battery and the motor and converts an output voltage of the second battery to a predetermined voltage.

### Advantageous Effects of Invention

According to the present disclosure, satisfactory power performance (desired power performance) can be obtained, and a battery according to a necessary cruising distance can be mounted.

### BRIEF DESCRIPTION OF DRAWINGS

FIG. 1 is a schematic diagram illustrating a state in which a replaceable large-capacity battery is connected in an electric power supply system according to an embodiment of the present disclosure; and

FIG. 2 is a schematic diagram illustrating a state in which a replaceable small-capacity battery is connected in the electric power supply system according to the embodiment of the present disclosure.

### DESCRIPTION OF EMBODIMENTS

Hereinafter, embodiments of the present disclosure will be described in detail with reference to the drawings. However, the embodiment described below is an example, and the present disclosure is not limited to this embodiment. For example, detailed descriptions of already well-known matters, a repetitive description for substantially the same configuration, and/or the like may be omitted.

<Configuration of Electric Power Supply System>

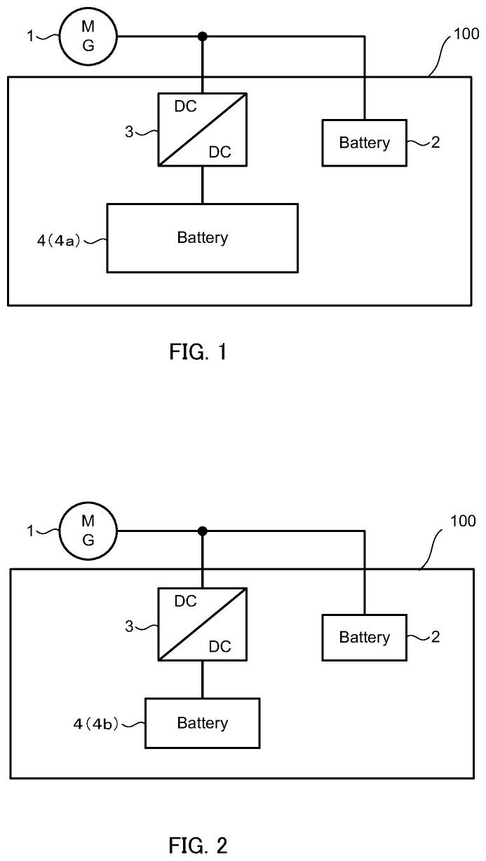

The configuration of electric power supply system 100 according to an embodiment of the present disclosure will be described in detail with reference to FIGS. 1 and 2.

Electric power supply system 100 supplies electric power to motor 1 that is mounted on a vehicle (not illustrated) and is a driving source of the vehicle. Here, motor 1 is connected to the drive wheels of the vehicle, and also functions as a motor generator (MG) that generates electric power by regenerating kinetic energy of the vehicle during deceleration of the vehicle.

Electric power supply system 100 includes battery 2, DC/DC converter 3, and battery 4.

Battery 2 is, for example, a battery capable of performing an output satisfying the power performance of the vehicle, supplies electric power to motor 1 and is charged with electric power generated by motor 1. Battery 2 is an output type battery having a smaller capacity and a higher output electric power than battery 4, and assists the driving of motor 1 by supplying electric power to motor 1 for several seconds to several tens of seconds, for example, at the time of acceleration immediately after the start of the vehicle or at the time of traveling up a slope. Battery 2 is, for example, a non-replaceable battery (a fixed battery) fixed to the vehicle.

DC/DC converter 3 is connected between motor 1 and battery 4, and includes an input/output terminal (not illustrated) connected to motor 1 and battery 2, and an input/output terminal (not illustrated) connected to battery 4. DC/DC converter 3 is a bidirectional DC/DC converter that supplies electric power supplied from battery 4 to motor 1 and supplies electric power supplied from motor 1 or battery 2 to battery 4. DC/DC converter 3 adjusts an output voltage in accordance with a charge-discharge current of battery 4. Further, the output voltage of battery 2 is converted into a predetermined voltage, and the output voltage of battery 4 is converted into a predetermined voltage. Battery 4 is, for example, a battery configured as replaceable for the vehicle.

DC/DC converter 3 can receive the output voltages of all replaceable batteries 4 as input voltages; that is, has a broad input voltage range. For example, DC/DC converter 3 has an input voltage range of from 10 V to 60 V such that both 12-V battery 4 and 48-V battery 4 can be used.

Battery 4 supplies electric power to motor 1 and is charged with electric power generated by motor 1. Battery 4 is a battery having a larger capacity than battery 2. Battery 4 is replaceable between battery 4a and battery 4b according to necessary cruising distances. Battery 4a has a larger capacity than battery 4b.

It should be noted that the invention is not limited to the case where battery 4 is replaceable between the two batteries of battery 4a and battery 4b, and three or more different-capacity batteries may be prepared and replaced as appropriate. In addition, battery 4 may be replaceable among used batteries or new batteries, or may be replaceable among a plurality of batteries having different charge and discharge voltages.

In electric power supply system 100 having the above-described configuration, for example, when battery 4 fails or is overdischarged, replacing battery 4 allows the vehicle to be self-propelled temporarily. In addition, in a battery-replaceable electric vehicle, a plurality of batteries 4 having different specifications can be used. Furthermore, when large-capacity battery 4 is not required because the vehicle is used for a shorter distance than in normal use, it is possible to temporarily replace battery 4 with lightweight small-capacity battery 4. It is thus possible to improve the electricity consumption.

As described above, according to the present embodiment, by including battery 2 that supplies electric power to motor 1 that drives the vehicle, battery 4 that supplies electric power to motor 1 and is replaceable, and DC/DC converter 3 that is connected between battery 4 and motor 1 and that converts the output voltage of battery 4 into a predetermined voltage, it is possible to obtain satisfactory power performance (desired power performance), and also to mount battery 4 according to the necessary cruising distance.

Note that the types, arrangements, numbers, and the like of members in the present invention are not limited to those in the above-described embodiments, and can naturally be changed appropriately without departing from the spirit of the invention. For example, it is possible to appropriately change a component of the present disclosure to another thing having the same effect.

Specifically, in the above-described embodiment, a switch or a relay configured to switch off the connection between DC/DC converter 3 and battery 4 when battery 4 is replaced, and switch on the connection between DC/DC converter 3 and battery 4 after the replacement of battery 4 is completed may be disposed between battery 4 and DC/DC converter.

### INDUSTRIAL APPLICABILITY

The present disclosure is suitable for an electric power supply system mounted in a vehicle.

1. An electric power supply system mounted in a vehicle, the electric power supply system comprising:
a first battery that supplies electric power to a motor that drives the vehicle;
a second battery that supplies electric power to the motor and is replaceable; and
a DC/DC converter that is connected between the second battery and the motor and converts an output voltage of the second battery to a predetermined voltage.

2. The electric power supply system according to claim 1, wherein
the first battery has a smaller capacity and a higher output electric power than the second battery.

3. The electric power supply system according to claim 1, wherein
the DC/DC converter supplies electric power generated by the motor to the second battery.

4. The electric power supply system according to claim 1, wherein
the first battery is not replaceable.

5. The electric power supply system according to claim 1, wherein
replacement of the second battery being replaceable is performed between two or more batteries having different capacities from each other.
